(19) United States
(12) Patent Application Publication
(10) Pub. No.: US 2006/0222065 A1
(43) Pub. Date: Oct. 5, 2006

(54) System and method for improving video data compression by varying quantization bits based on region within picture

(76) Inventor: Lakshmanan Ramakrishnan, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/135,903

(22) Filed: May 24, 2005

Related U.S. Application Data
(60) Provisional application No. 60/668,214, filed on Apr. 4, 2005.

(51) Int. Cl. H04N 11/04; H04N 11/02; H04B 1/66; H04N 7/12

(52) U.S. Cl. 375/240.03; 375/240.24; 375/240.18; 375/240.12

(57) ABSTRACT

Presented herein is a system and method for improving video data compression by varying quantization bits based on a region within picture. In one embodiment, there is presented a method for encoding video data. The method comprises dividing a picture into a plurality of blocks; compressing a particular one of the plurality of blocks with lossless compression; measuring how far the particular block is from a center of the picture; and compressing the particular one of the blocks with lossy compression, wherein information loss is based on how far the particular block is from the center of the picture.

### RELATED APPLICATIONS

This application claims priority to “SYSTEM AND METHOD FOR IMPROVING VIDEO DATA COMPRESSION BY VARYING QUANTIZATION BITS BASED ON REGION WITHIN PICTURE”, U.S. Provisional Patent Application Ser. No. 60/668,214, filed Apr. 4, 2005, by Lakshmanan Ramakrishnan, which is incorporated herein by reference for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video data comprises large amounts of data. For example, uncompressed standard definition television video comprises 500 KB per picture. At thirty pictures per second, one second of uncompressed video comprises 15 MB. Therefore, the storage and transfer of uncompressed video data requires memory and bandwidth amounts that may not be commercially feasible.

Accordingly, a number of compression standards are available that can significantly compress the video data. For example, the Motion Picture Experts Group (MPEG) developed a standard known as MPEG-2 for compressing video data. The Joint Video Telecommunications (JVT) group and MPEG jointly developed the ITU-H.264 (H.264) standard (also known as Advanced Video Coding and MPEG-4, Part 10). Compressing the video data can significantly reduce the memory and bandwidth requirements for storing and transferring the video data.

The H.264 standard was developed with the goal of compressing high definition television (HDTV) for transfer over cable, satellite, and the internet. Uncompressed HDTV video comprises 3 MB per picture or 90 MB per second. While the H.264 standard allows transfer of HDTV over cable satellite, and the internet, it may be desirable to transfer HDTV over other communication media, such as wireless internet. Such communication media may have bandwidth limitations that require further compression for the transfer of HDTV.

Additionally, the H.264 standard is computationally intense and consumes large amounts of processing to decode. It may be desirable to utilize a less computationally intense standard. However, the less computationally intense standards may not achieve the requisite compression.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein is a system and method for improving video data compression by varying quantization bits based on a region within a picture.

In one embodiment, there is presented a method for encoding video data. The method comprises dividing a picture into a plurality of blocks; compressing a particular one of the plurality of blocks with lossless compression; measuring how far the particular block is from a center of the picture; and compressing the particular one of the blocks with lossy compression, wherein information loss is based on how far the particular block is from the center of the picture.

In another embodiment, there is presented a video encoder for encoding video data. The video encoder comprises a lossless compression engine, a controller, and a lossy compression engine. The lossless compression engine compresses a block of the picture with lossless compression. The controller measures how far the particular block is from a center of the picture. The lossy compression engine compresses the blocks with lossy compression, wherein information loss is based on how far the particular block is from the center of the picture.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a block diagram describing exemplary video data;

FIG. 2 is a flow diagram for encoding the video data in accordance with an embodiment of the present invention;

FIG. 3 is an exemplary video encoder in accordance with an embodiment of the present invention;

FIG. 4 is a block diagram describing compression of video data;

FIG. 5A is a block diagram describing spatial prediction;

FIG. 5B is a block diagram describing temporal prediction;

FIG. 5C is a block diagram describing transformation of a macroblock into the frequency domain; and

FIG. 6 is a block diagram describing an exemplary video encoder in accordance with an embodiment of the present invention.

### DETAILED DESCRIPTION OF THE INVENTION

Certain aspects of the present invention improve video data compression by increasing lossy compression associated with areas further away from the center of each picture.

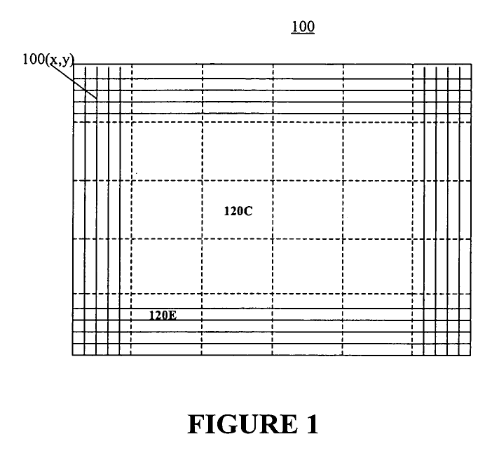

Referring now to FIG. 1, there is illustrated a block diagram of exemplary video data. The video data comprises a series of pictures 100. When the pictures 100 are displayed on a display device, the pictures 100 simulate motion picture. Each picture comprises two dimensional grid(s) of pixels 100(x,y). The location of pixel 100(x,y) within the grid is indicative of the location that the pixel is displayed on the display device.

Common video compression standards divide the pictures 100 into smaller blocks 120(x,y) of pixels. The blocks 120(x,y) comprise two-dimensional grid(s) of pixels and correspond to a region of the display device. The pixels from a block 120(x,y) are displayed in the region corresponding to the block 120(x,y).

The smaller blocks 120(x,y) of pixels can be compressed using both lossy and lossless compression. Lossless compression compresses data without information loss, while lossy compression results in information loss. Preferably, the viewer does not perceive the information loss. Better lossy compression rates are realized with more information loss. However, with more information loss, the information loss becomes more perceivable.

Generally, viewers focus attention on the center of the display device, making information loss in the pixels 100(x,y) near the center of the picture most perceivable. Conversely, viewers tend to focus less attention at the edges of the display device, making information loss in the pixels 100(x,y) near the edge least perceivable. Accordingly, more information loss can be allowed for the lossy compression that is applied to the blocks 120(x,y) further away from the center, e.g., 120E, than the blocks 120(x,y) closer to the center, e.g., 120C.

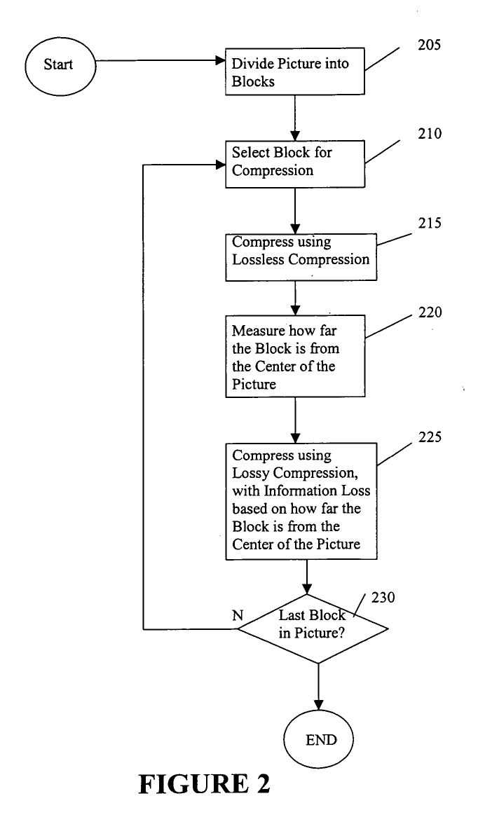

Referring now to FIG. 2, there is illustrated a flow diagram for encoding video data in accordance with an embodiment of the present invention. At 205, a picture is divided up into blocks. According to certain aspects of the present invention, the block can comprise a macroblock. At 210, a block 120 is selected for compression.

At 215, lossless compression is applied to the block 120. Lossless compression can comprise any one of a number of compression techniques, such as, but not limited to, motion compensation, spatial prediction, and transformations to the frequency domain. Transformation to the frequency domain can include, for example, the discrete cosine transformation.

At 220, a determination is made regarding how far the block 120 is towards the center of the picture. At 225, lossy compression is applied to the block 120, wherein the amount of allowable information loss depends on how far the block 120 is from the center of the picture 100. The lossy compression can comprise, for example quantization of frequency coefficients resulting from transformation to the frequency domain into bits. Until lossy compression is applied to the last block 120 in the picture at 230, 210-225 are repeated. For each picture, 205-230 can be repeated.

According to certain aspects of the present invention, the number bits used for quantizing the frequency coefficients can depend on how far the block 120 is from the center of the picture 100. For example, more bits can be used to quantize the frequency coefficients where the block 120 is close to the center of the picture 100 as compared to the number of bits to quantize the frequency coefficients where the block 120 is far from the center of the picture 100.

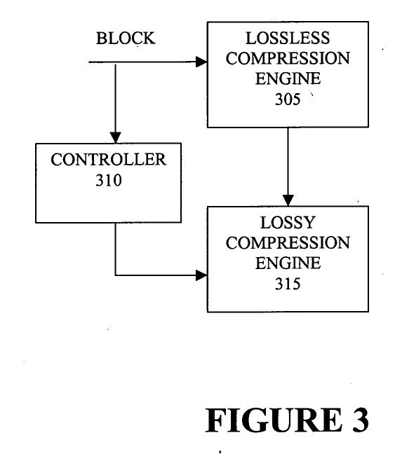

Referring now to FIG. 3, there is illustrated a block diagram of an exemplary video encoder in accordance with an embodiment of the present invention. The video encoder 300 comprises a lossless compression engine 305, a controller 310, and a lossy compression engine 315.

The lossless compression engine 305 compresses a block 120 of the picture with lossless compression. According to certain aspects of the invention, the lossless compression engine 305 can comprise a motion estimator, a subtractor, or a transformation engine. The transformation engine can represent the block with frequency coefficients.

The controller 310 measures how far the particular block 120 is from a center of the picture. The controller 310 can comprises a processor, or a logic core. The lossy compression engine 315 compresses the block with lossy compression. The amount of information loss that is allowed is based on how far the block 120 is from the center of the picture 100.

The lossy compression engine 315 can comprise a quantizer for quantizing the frequency coefficients with bits, wherein the number bits is based on the how far the particular block is from the center of the picture. For example, the number of bits quantizing the frequency coefficients can be greater if the particular block is close to the center of the picture as compared to where the block is far from the center of the picture.

An exemplary compression standard, H.264, will now be described by way of example to illustrate how certain embodiments of the invention can improve compression of video data. Although the H.264 standard is described, the present invention is not limited to the H.264 standard and can be used with other standards as well.

H.264 Standard

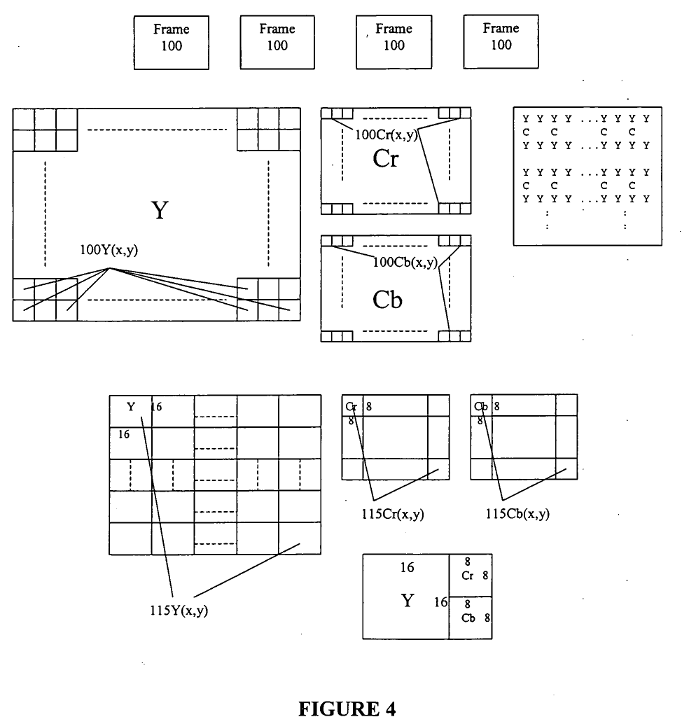

Referring now to FIG. 4, there is illustrated a block diagram of a frame 100. A video camera captures frames 100 from a field of view during time periods known as frame durations. The successive frames 100 form a video sequence. A frame 100 comprises two-dimensional grid(s) of pixels 100(x,y). For color video, each color component is associated with a two-dimensional grid of pixels. For example, a video can include a luma, chroma red, and chroma blue components. Accordingly, the luma, chroma red, and chroma blue components are associated with a two-dimensional grid of pixels 100Y(x,y), 100Cr(x,y), and 100Cb(x,y), respectively. When the grids of two dimensional pixels 100Y(x,y), 100Cr(x,y), and 100Cb(x,y) from the frame are overlayed on a display device 110, the result is a picture of the field of view at the frame duration that the frame was captured.

Generally, the human eye is more perceptive to the luma characteristics of video, compared to the chroma red and chroma blue characteristics. Accordingly, there are more pixels in the grid of luma pixels 100Y(x,y) compared to the grids of chroma red 100Cr(x,y) and chroma blue 100Cb(x,y). In the MPEG 4:2:0 standard, the grids of chroma red 100Cr(x,y) and chroma blue pixels 100Cb(x,y) have half as many pixels as the grid of luma pixels 100Y(x,y) in each direction.

The chroma red 100Cr(x,y) and chroma blue 100Cb(x,y) pixels are overlayed the luma pixels in each even-numbered column 100Y(x, 2y) between each even, one-half a pixel below each even-numbered line 100Y(2x, y). In other words, the chroma red and chroma blue pixels 100Cr(x,y) and 100Cb(x,y) are overlayed pixels 100Y(2x+½, 2y).

A luma pixels of the frame 100Y(x,y), or top/bottom fields 110YT/B(x,y) can be divided into 16×16 pixel 100Y(16x->16x+15, 16y->16y+15) blocks 115Y(x,y). For each block of luma pixels 115Y(x,y), there is a corresponding 8×8 block of chroma red pixels 115Cr(x,y) and chroma blue pixels 115Cb(x,y) comprising the chroma red and chroma blue pixels that are to be overlayed the block of luma pixels 115Y(x,y). A block of luma pixels 115Y(x,y), and the corresponding blocks of chroma red pixels 115Cr(x,y) and chroma blue pixels 115Cb(x,y) are collectively known as a macroblock 120. The macroblocks 120 can be grouped into groups known as slice groups.

The ITU-H.264 Standard (H.264), also known as MPEG-4, Part 10, and Advanced Video Coding, encodes video on a picture by picture 100 basis, and encodes pictures on a macroblock 120 by macroblock 120 basis. H.264 specifies the use of lossless compression as well as lossy compression for compressing macroblocks 120. The lossless compression includes spatial prediction, temporal prediction, and transformations. The lossy compression includes quantization.

Lossless Compression

Spatial Prediction

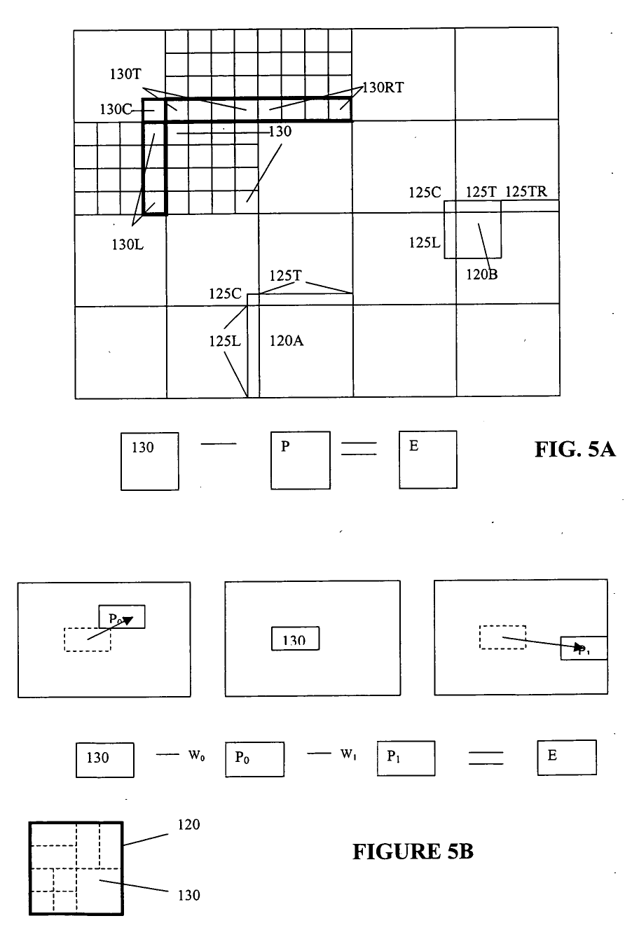

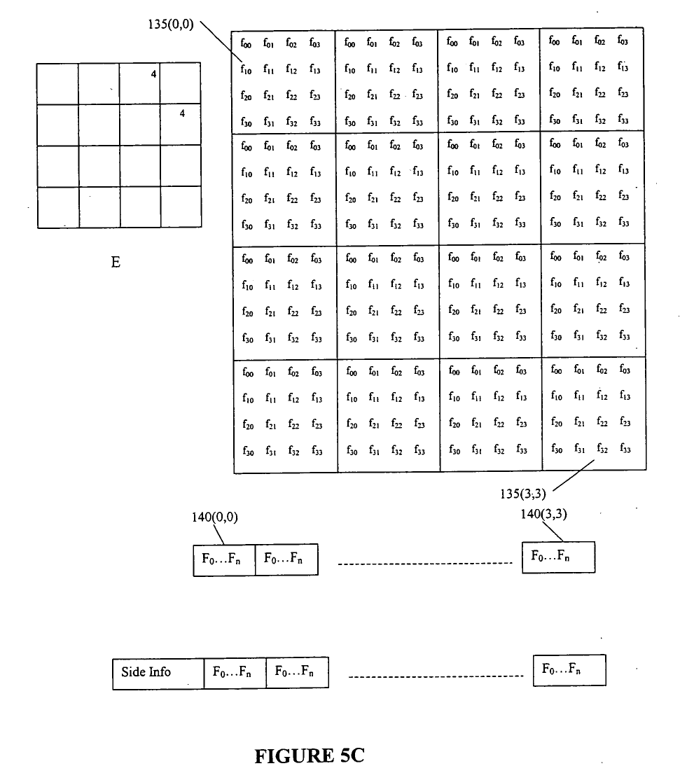

Referring now to FIG. 5A, there is illustrated a block diagram describing spatially encoded macroblocks 120. Spatial prediction, also referred to as intraprediction, involves prediction of frame pixels from neighboring pixels. The pixels of a macroblock 120 can be predicted, either in a 16×16 mode, an 8×8 mode, or a 4×4 mode.

In the 16×16 and 8×8 modes, e.g, macroblock 120a, and 120b, respectively, the pixels of the macroblock are predicted from a combination of left edge pixels 125L, a corner pixel 125C, and top edge pixels 125T. The difference between the macroblock 120a and prediction pixels P is known as the prediction error E. The prediction error E is calculated and encoded along with an identification of the prediction pixels P and prediction mode, as will be described.

In the 4×4 mode, the macroblock 120c is divided into 4×4 partitions 130. The 4×4 partitions 130 of the macroblock 120a are predicted from a combination of left edge partitions 130L, a corner partition 130C, right edge partitions 130R, and top right partitions 130TR. The difference between the macroblock 120a and prediction pixels P is known as the prediction error E. The prediction error E is calculated and encoded along with an identification of the prediction pixels and prediction mode, as will be described. A macroblock 120 is encoded as the combination of the prediction errors E representing its partitions 130.

Temporal Prediction

Referring now to FIG. 4B, there is illustrated a block diagram describing temporally encoded macroblocks 120. The temporally encoded macroblocks 120 can be divided into 16×8, 8×16, 8×8, 4×8, 8×4, and 4×4 partitions 130. Each partition 130 of a macroblock 120, is compared to the pixels of other frames or fields for a similar block of pixels P. A macroblock 120 is encoded as the combination of the prediction errors E representing its partitions 130.

The similar block of pixels is known as the prediction pixels P. The difference between the partition 130 and the prediction pixels P is known as the prediction error E. The prediction error E is calculated and encoded, along with an identification of the prediction pixels P. The prediction pixels P are identified by motion vectors MV. Motion vectors MV describe the spatial displacement between the partition 130 and the prediction pixels P. The motion vectors MV can, themselves, be predicted from neighboring partitions.

The partition can also be predicted from blocks of pixels P in more than one field/frame. In bi-directional coding, the partition 130 can be predicted from two weighted blocks of pixels, P₀ and P₁. Accordingly, a prediction error E is calculated as the difference between the weighted average of the prediction blocks w₀P₀+w₁P₁ and the partition 130. The prediction error E, an identification of the prediction blocks P₀, P₁ are encoded. The prediction blocks P₀ and P₁ are identified by motion vectors MV.

The weights w₀, w₁ can also be encoded explicitly, or implied from an identification of the field/frame containing the prediction blocks P₀ and P₁. The weights w₀, w₁ can be implied from the distance between the frames/fields containing the prediction blocks P₀ and P₁ and the frame/field containing the partition 130. Where T₀ is the number of frame/field durations between the frame/field containing P₀ and the frame/field containing the partition, and T₁ is the number of frame/field durations for P₁,
w₀=1−T₀/(T₀+T₁)
w₁=1−T₁/(T₀+T₁)
Transformations

Referring now to FIG. 5C, there is illustrated a block diagram describing the encoding of the prediction error E. With both spatial prediction and temporal prediction, the macroblock 120 is represented by a prediction error E. The prediction error E is also two-dimensional grid of pixel values for the luma Y, chroma red Cr, and chroma blue Cb components with the same dimensions as the macroblock 120. Transformations transforms 4×4 partitions 130(0,0) . . . 130(3,3) of the prediction error E to the frequency domain, thereby resulting in corresponding sets 135(0,0) . . . 135(3,3) of frequency coefficients f₀₀ . . . f₃₃.

Lossy Compression—Quantization

The sets of frequency coefficients are then quantized and scanned, resulting in sets 140(0,0) . . . 140(3,3) of quantized frequency coefficients, F₀ . . . Fₙ. A macroblock 120 is encoded as the combination of its partitions 130.

According to certain aspects of the present invention, the number bits used for quantizing the frequency coefficients can depend on how far the macroblock 120 is from the center of the picture 100. For example, more bits can be used to quantize the frequency coefficients where the macroblock 120 is close to the center of the picture 100 as compared to the number of bits to quantize the frequency coefficients where the block 120 is far from the center of the picture 100.

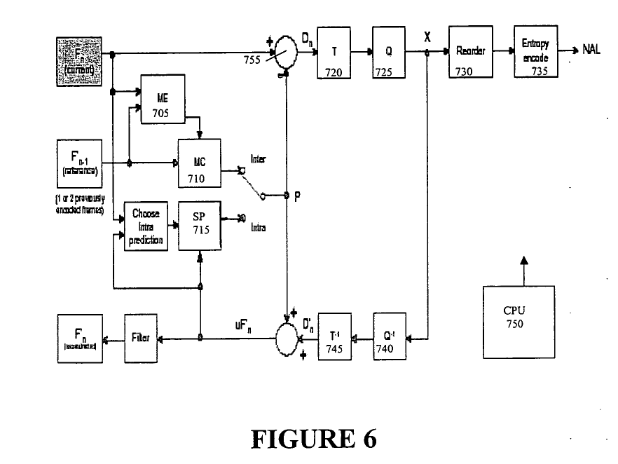

Referring now to FIG. 6, there is illustrated a block diagram describing an exemplary video encoder in accordance with an embodiment of the present invention. The video encoder encodes video data comprising a set of pictures F₀ . . . . Fₙ. The video encoder comprises motion estimators 705, motion compensators 710, spatial predictors 715, transformation engine 720, quantizer 725, scanner 730, entropy encoders 735, inverse quantizer 740, and inverse transformation engine 745. The foregoing can comprise hardware accelerator units under the control of a CPU 750.

When an input frame Fₙ is presented for encoding, the video encoder processes the frame Fₙ in units of macroblocks. The video encoder can encode each macroblock using either spatial or temporal prediction. In each case, the video encoder forms a prediction block P. In spatial prediction mode, the spatial predictors 715 form the prediction macroblock P from samples of the current frame Fₙ that was previously encoded. In temporal prediction mode, the motion estimators 705 and motion compensators 710 form a prediction macroblock P from one or more reference frames. Additionally, the motion estimators 705 and motion compensators 710 provide motion vectors identifying the prediction block. The motion vectors can also be predicted from motion vectors of neighboring macroblocks.

A subtractor 755 subtracts the prediction macroblock P from the macroblock in frame Fₙ, resulting in a prediction error E. Transformation engine 720 and quantizer 725 block transform and quantize the prediction error E, resulting in a set of quantized transform coefficients X.

According to certain aspects of the present invention, the number bits that the quantizer 725 uses for quantizing the frequency coefficients can depend on how far the macroblock 120 is from the center of the picture 100. The CPU can measure how far the macroblocks 120 are from the center of the picture 100. For example, the quantizer 725 can use more bits to quantize the frequency coefficients where the macroblock 120 is close to the center of the picture 100 as compared to the number of bits to quantize the frequency coefficients where the macroblock 120 is far from the center of the picture 100.

The scanner 730 reorders the quantized transform coefficients X. The entropy encoders 735 entropy encode the coefficients.

The video encoder also decodes the quantized transform coefficients X, via inverse transformation engine 745, and inverse quantizer 740, in order to reconstruct the frame Fₙ for encoding of later macroblocks 120, either within frame Fₙ or other frames.

The embodiments described herein may be implemented as a board level product, as a single chip, application specific integrated circuit (ASIC), or with varying levels of the decoder system integrated with other portions of the system as separate components.

The degree of integration of the decoder system will primarily be determined by the speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope.

Therefore, it is intended that the present invention not be limited to the particular embodiment disclosed, but that the present invention will include all embodiments falling within the scope of the appended claims.

1. A method for encoding video data, said method comprising:
dividing a picture into a plurality of blocks;
compressing a particular one of the plurality of blocks with lossless compression;
measuring how far the particular block is from a center of the picture; and
compressing the particular one of the blocks with lossy compression, wherein information loss is based on how far the particular block is from the center of the picture.

2. The method of claim 1, wherein dividing the picture comprises:
dividing the picture into macroblocks.

3. The method of claim 1, wherein the lossless compression comprises representing the particular block with frequency coefficients.

4. The method of claim 3, wherein representing the particular with frequency coefficients further comprises:
predicting the particular block, from a prediction block;
calculating a prediction error between the block and the prediction block; and
transforming the prediction error to a frequency domain.

5. The method of claim 3, wherein the lossy compression comprises quantizing the frequency coefficients with bits, wherein the number bits is based on the how far the particular block is from the center of the picture.

6. The method of claim 5, wherein the number of bits quantizing the frequency coefficients is greater if the particular block is close to the center of the picture and fewer if the block is far from the center of the picture.

7. A video encoder for encoding video data, said video encoder comprising:
a lossless compression engine for compressing a block of the picture with lossless compression;
a controller for measuring how far the particular block is from a center of the picture; and
a lossy compression engine for compressing the blocks with lossy compression, wherein information loss is based on how far the particular block is from the center of the picture.

8. The video encoder of claim 7, wherein the block comprises a macroblock.

9. The video encoder of claim 7, wherein the lossless compression engine comprises a transformation engine for representing the block with frequency coefficients.

10. The video encoder of claim 9, wherein the lossless compression engine comprises:
a motion estimator for predicting the particular block, from a prediction block;
a subtractor for calculating a prediction error between the block and the prediction block; and
wherein the transformation engine transforms the prediction error to a frequency domain.

11. The video encoder of claim 9, wherein the lossy compression engine comprises a quantizer for quantizing the frequency coefficients with bits, wherein the number of bits is based on the how far the particular block is from the center of the picture.

12. The video encoder of claim 11, wherein the number of bits quantizing the frequency coefficients is greater if the particular block is close to the center of the picture and fewer is the block is far from the center of the picture.
